(19) United States
(12) Patent Application Publication
(10) Pub. No.: US 2022/0217947 A1
(43) Pub. Date: Jul. 14, 2022

(54) ROBUST LEASH MARKING SYSTEMS AND METHODS

(71) Applicant: Buttonsmith Inc, Carnation, WA (US)

(72) Inventor: Darcy Burner, Redmond, WA (US)

(73) Assignee: Buttonsmith Inc, Carnation, WA (US)

(21) Appl. No.: 17/145,174

(22) Filed: Jan. 8, 2021

(51) Int. Cl. A01K 27/00

(52) U.S. Cl. CPC A01K 27/003

(57) ABSTRACT

Methods and systems are presented to configure leashes using a commercial heat press. A first or second strap (or both) is marked adjacent one or more hot platens. Then a handle assembly of a leash is configured to include a handle and a handle support that both extend between first and second joints, with the handle being longer than the handle support and being strongly connected to a distal portion of the leash (i.e. away from the user).

### BRIEF DESCRIPTION OF THE DRAWINGS

FIG. 1 illustrates a leash configuration system as a completed leash made of a plurality of straps in which one or more technologies may be implemented.

FIG. 2 illustrates a facility in which straps have been placed on a platen of a commercial heat press in which one or more technologies may be implemented.

FIG. 3 illustrates an augmented leash handle assembly in which one or more technologies may be implemented.

FIG. 4 illustrates other leash handle structure in which one or more technologies may be implemented.

FIG. 5 illustrates additional leash handle structure in which one or more technologies may be implemented.

FIG. 6 illustrates a manufacturing flow in which one or more technologies may be implemented.

FIG. 7 illustrates another leash configuration aspect in which one or more technologies may be implemented.

FIG. 8 illustrates yet another leash configuration aspect in which one or more technologies may be implemented.

### DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“About,” “across,” “additional,” “adjacent,” “adjusted,” “affixed,” “along,” “alternatively,” “another,” “arranged,” “augmented,” “before,” “between,” “between,” “big,” “both,” “by virtue of,” “central,” “comprising,” “configured,” “directly,” “distal,” “endmost,” “engaged,” “enough,” “exceeding,” “extending,” “first,” “for,” “formed,” “having,” “heated,” “indirectly,” “intermediate,” “longer,” “medium-sized,” “more,” “narrower,” “obtained,” “of,” “opposite,” “proximal,” “roughly,” “safely,” “second,” “shorter,” “strength-indicative,” “thereon,” “thinner,” “third,” “through,” “unsuitable,” “using,” “via,” “weak,” “wherein,” “wide,” “within,” “without,” or other such descriptors herein are used in their normal yes-or-no sense, not merely as terms of degree, unless context dictates otherwise. In light of the present disclosure those skilled in the art will understand from context what is meant by “configured” or “enough” and by other such relational descriptors used herein. As used herein two quantities are “about” equal if they differ by a factor of less than two and they are “roughly” equal if they differ by a factor of less than five. Other descriptors as used but not explicitly defined herein will all be adequately clear and definite from context, in light of teachings herein.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

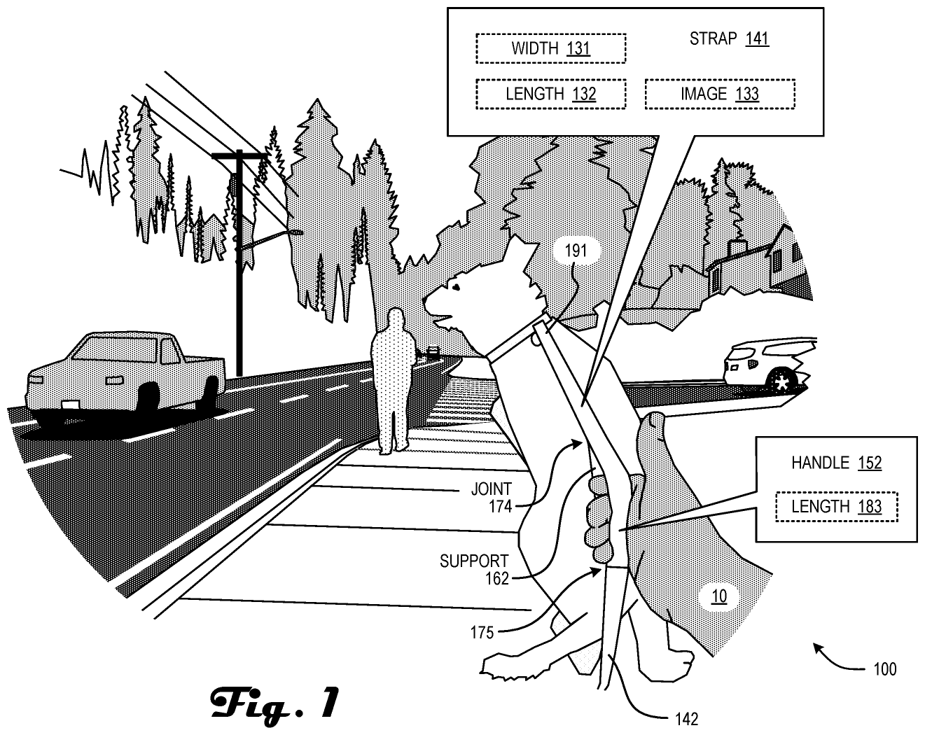

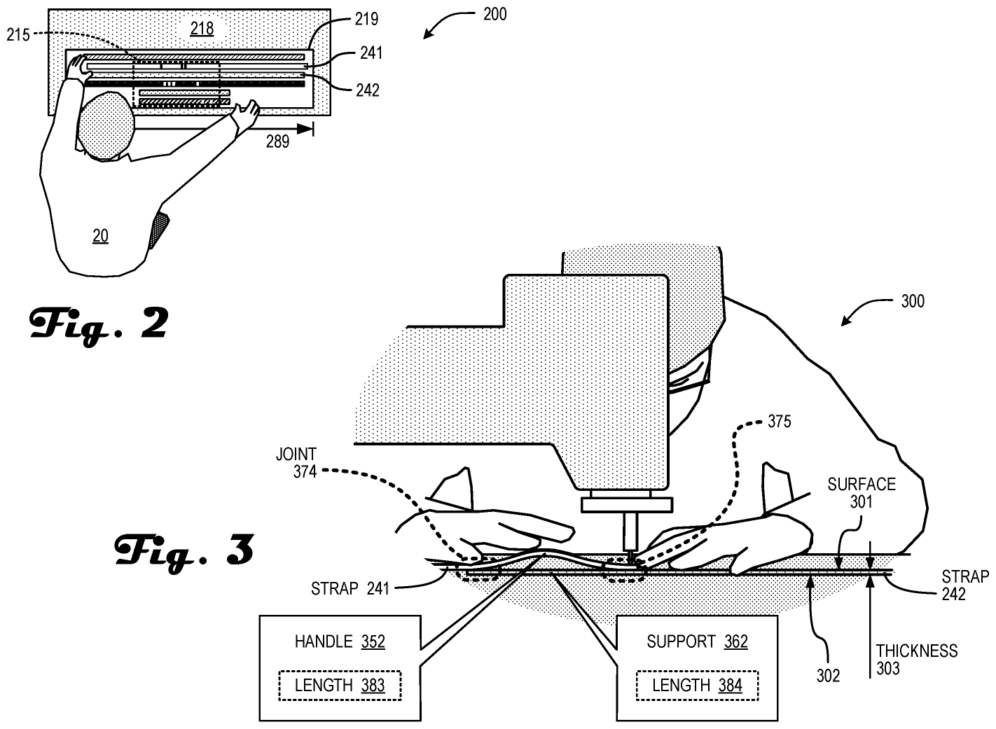

FIG. 1 depicts a leash configuration system 100 as a completed dog leash comprising a plurality of straps 141, 142 at least one of which has been robustly customized with a commercial heat press (e.g. see FIG. 2). The assembled leash has an intermediate handle 152 that a user 10 may prefer for greater control in crowded spaces. The assembled leash is longer than the heat press platens used for such customization, but the component straps 141, 142 thereof each have a length 132 that is shorter than the platens. The straps form a D-shaped assembly such that a (proximal) longer portion of the first strap 141 comprises a handle 152 and a (distal) shorter portion of the second strap 142 comprises a corresponding handle support 162. Stitched joints 174, 175 are formed at opposite ends of the handle 152 and support 162 such that the length 183 of the handle 152 exceeds that of the support 162 by about 2 cm. As shown each strap has a width 131 of about 2 cm and a length 132 of about 80 cm. Even for a lightweight leash (e.g. having a nominal strap thickness of 1.2 mm or less) an especially secure connection is formed by providing a single strap 141 extending all the way from a distal end portion 191 and also through the first handle 152. The straps may be a woven material in which a substantial component 135 is polyester (i.e. more than 40% by weight).

FIG. 2 depicts a factory or other facility 200 in which a worker 20 is preparing to heat at least first and second straps 241, 242 (e.g. to apply one or more images thereon) in a commercial heat press 218. As shown each strap lies flat adjacent a heat press platen 219 or between platens. Commercial-grade platen lengths 289 are shorter than almost any dog leash, previously making this application untenable because inadequately uniform heating would cause a simple leash to undergo substantial enough heat-discoloration gradients to become noticeable along the leash. This can occur, for example, in a context in which no unheated image application technologies would create adequately cost-effective image placement that is both sharp and durable. A replicated occasion-specific image or novelty image, for example, may be deposited via a printer in sublimation ink onto transfer paper 215 above or below (or both) one or more straps to be marked.

As used herein a “length” of a strap refers to its longest dimension unless context dictates otherwise. The “length” of a platen or other item, however, refers to its dimension (nominally) along a strap unless context dictates otherwise. In some contexts, for example, a platen may have a width that is greater than its length. Also as used herein items may be “adjacent” if they are within 2 centimeters even if paper, fabric, or other thin layers of material are situated between them.

FIG. 3 depicts a handle assembly 300 in which the first strap 241 or the second strap 242 (or both) of FIG. 2 has been marked with lettering or other images with a heat treatment, making it much easier and more natural for a user 10 to grip. As shown the handle assembly 300 has joints 374, 375 at each end thereof so that the handle 352 has a length 383 that is greater than a length 384 of the corresponding support 362 by roughly 2 centimeters. This can occur, for example, in a context in which the straps 241, 242 each have a respective (nominal) thickness 303 of 0.6 to 1.1 millimeters and a width 131 of 1.8 to 2.6 centimeters; and in which such a lightweight first strap 241 would not be suitable for managing a big dog without an augmented intermediate handle assembly 300 as described herein. This can occur, for example, in a context in which a less-augmented design would otherwise allow the more-distal joint 174, 374 to suffer damage or fail when in use with a strong dog trying to chase a squirrel. Alternatively or additionally, in some contexts, handle assembly 300 may be configured so that an (instance of) image 133 is placed and (at least part of) the second strap 242 are affixed to opposite surfaces 301, 302 of the first strap 241.

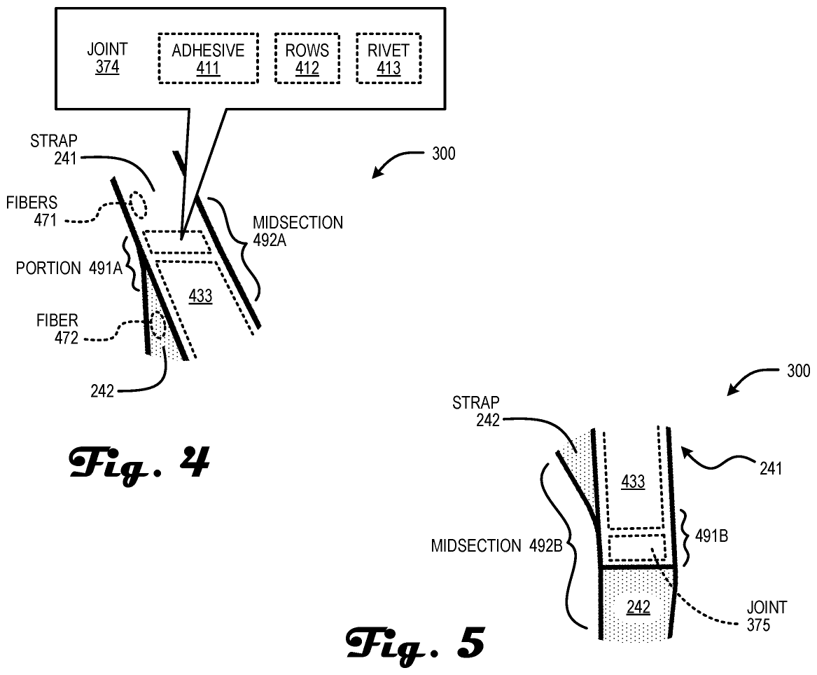

FIG. 4 depicts another view of the handle assembly 300 of FIG. 3, on in which a vicinity of the first joint 374 (comprising one or more instances of adhesives 411, rows 412 of stitches, or rivets 413) is magnified. Joint 374 is where an end portion 491A of the second strap 242 is directly or otherwise coupled adjacent a midsection 492A of the first strap 241 (near a proximal end thereof). In this configuration numerous fibers 471 (i.e. hundreds or more) of said first strap 241 each extend between a distal end portion (i.e. farthest from a human leash user 10) of said first strap 241 continuously and through the first handle 352 thereof but no single fiber 472 extends between (any part of) the corresponding support 362 and the opposite (distal) end portion of said first strap 241. Moreover an image 433 as shown has been durably affixed (e.g. by a heat press 218 like that of FIG. 2) onto an outward-facing surface 302 (i.e. opposite an interior) of the handle assembly 300.

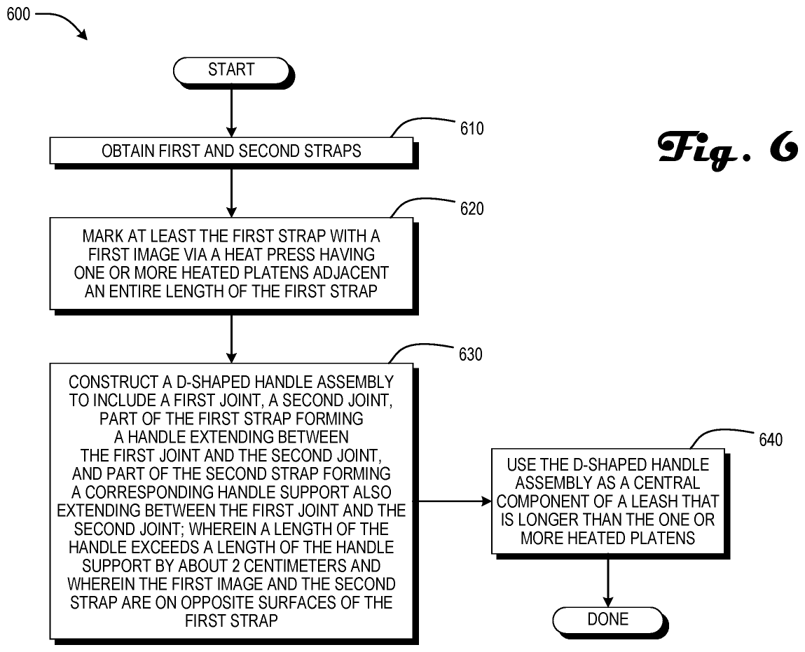

FIG. 5 depicts another view of the handle assembly 300 of FIG. 3, focusing on a vicinity of the second joint 375. Joint 375 is where an end portion 491B of the first strap 241 is directly or otherwise coupled adjacent a midsection 492B of the second strap 242 (several centimeters away from a distal end thereof). Moreover a proximal end of image 433 has been durably affixed (e.g. by a heat press 218 like that of FIG. 2) onto an outward-facing surface 302 of the handle assembly 300.

FIG. 600 illustrates an operational flow 600 (e.g. performed by one or more workers 20) suitable for use with at least one embodiment. As will be recognized by those having ordinary skill in the art, not all events of sourcing, manufacture, distribution, or use are illustrated in FIG. 6. Rather, for clarity, only those steps reasonably relevant to durable labeling and handle assemblies are shown and described. Those having ordinary skill in the art will also recognize the present embodiment is merely one exemplary embodiment and that variations on the present embodiment may be made without departing from the scope of the broader inventive concept set forth in the clauses and claims below.

Operation 610 describes obtaining two or more straps for use in a leash assembly. This can occur, for example, in a context in which all of the component straps for a given assembly 300 are cut from a single roll (e.g. with a hot knife).

Operation 620 describes marking at least the first strap with a first image via a heat press having one or more heated platens adjacent an entire length of the first strap. This can occur, for example, in a context in which at least one of the straps was cut short enough to fit entirely within a commercial heat press 218; in which transfer paper 215 is used for placing one or more images 133, 433 (e.g. on both surfaces 301, 302 of a given strap 241, 242) including the first image simultaneously. Alternatively or additionally, the first image 133 may comprise a strength-indicative rating or other design specification (e.g. a maximum dog weight for which the leash is deemed safe), a composition identifier, or a source identifier.

Operation 630 describes constructing a D-shaped handle assembly to include a first joint, a second joint, part of the first strap forming a handle extending between the first joint and the second joint, and part of the second strap forming a corresponding handle support also extending between the first joint and the second joint. This can occur, for example, in a context in which a length of a leash-midsection handle exceeds a length of the corresponding handle support by about 2 centimeters or in which the first image and the second strap are on opposite surfaces of the first strap (or both).

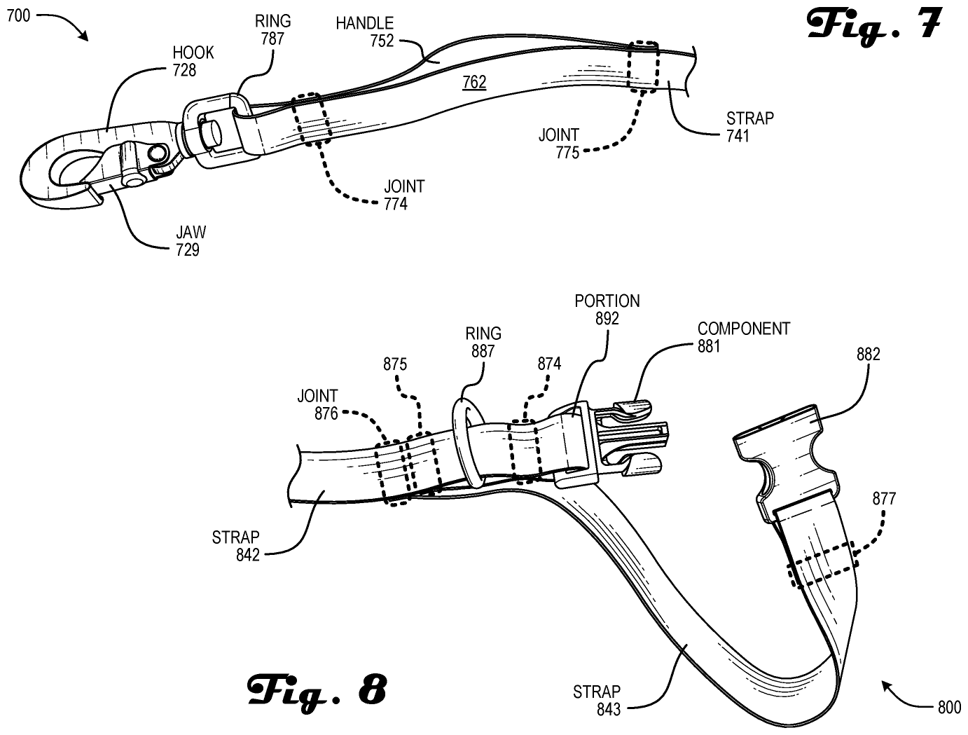

Operation 640 describes using the D-shaped handle assembly as a central component of a leash that is longer than the one or more heated platens. This can occur, for example, in a context in which such a strong connection between the handle and the distal end could not otherwise be achieved with such cost-effective slender and thin straps and in which the distal end is configured generally as shown in FIG. 7. Alternatively or additionally, a proximal end of the resulting leash may be configured generally as shown in FIG. 8.

FIG. 7 depicts a leash configuration system 700 that can include an intermediate handle assembly 300 (as described above) or can implement a distal end of system 100 (or both). Strap 741 as shown in FIG. 7 is a (distal) “first” strap 141, 241 like those described above and can include some or all features of strap 141 as shown in FIG. 1 or of strap 241 as shown in FIGS. 2-5 (or both). As shown an endmost portion of the “first” strap 141, 241, 741 has passed through a ring 787 of a swivel snap hook with a hook 728 and jaw 729 as shown. The jaw 729 is spring-biased outward so that no fine manipulation is needed when engaging a ring (e.g. of a leash or harness) worn by a dog. A (distal) second handle assembly is shown in which an endmost strap portion serves as a distal second handle 752 and in which a strap midsection serves as a corresponding support 762. As shown the second handle assembly has joints 774, 775 at each end thereof so that the handle 752 has a length 383 that is greater than a length 384 of the corresponding support 762 by roughly 2 centimeters. This can occur, for example, in a context in which strap 741 has a (nominal) thickness of 0.6 to 1.1 millimeters or a width of 1.8 to 2.6 centimeters (or both). A distal D-type handle 752 of this general type typically will not be as vulnerable and failure-prone as an intermediate D-type handle of similar design in actual use.

FIG. 8 depicts a leash configuration system 800 that can likewise include an intermediate/central handle assembly 300 (as described above) or can implement a distal end of system 100 (or both). Strap 842 as shown in FIG. 8 is a more-proximal “second” strap 142, 242 like those described above and can include some or all features of strap 142 as shown in FIG. 1 or of strap 242 as shown in FIGS. 2-5 (or both). As shown a proximal endmost portion 892 of the “second” strap 142, 242, 842 extends through a ring 887 and a (male) first snap-clip component 881. The ring 887 is secured to the “second” strap 142, 242, 842 by a pair of joints 874, 875 one of which joints 874 also secures the first snap-clip component 881 to the intermediate/central handle assembly 300. A third strap 843 is affixed to the “second” strap 142, 242, 842 with another joint 876 as shown. Yet another joint 877 affixes an opposite end of the third strap 843 with a (female) second snap-clip component 882, making the resulting system 800 ideal for hitching a dog to a stationary post, loop, or other suitable docking fixture around which the snap-clip components 881, 882 can engage. When departing, the snap-clip components 881, 882 can then be separated, removed from the docking fixture, and re-engaged to form a proximal looped handle. Alternatively or additionally, one or more straps 741, 842, 843 of a 3-strap leash may have been customized or otherwise durably marked before assembly as described above with reference to a commercial heat press 218 like that of FIG. 2.

In light of teachings herein, numerous existing techniques may be applied for configuring structures and materials as described herein without undue experimentation. See, e.g., U.S. patent Ser. No. 10/624,314 (“Animal harness with attachable garment”); U.S. patent Ser. No. 10/589,517 (“Metal photographic plate with carrier and method of use”); U.S. patent Ser. No. 10/028,856 (“Protective shields for protecting the limbs of injured animals”); U.S. Pat. No. 9,861,183 (“Equipment carrier with extensible tether”); U.S. Pat. No. 9,617,726 (“Butt joint flashing system”); U.S. Pat. No. 9,609,845 (“Portable pet carrier restraint system”); U.S. Pat. No. 9,247,717 (“Retractable flat belt reflective pet leash”); U.S. Pat. No. 6,471,560 (“Surf leash and method of making surf leash”); U.S. Pub. No. 2017/0068270 (“Improved support for a portable computer”); and U.S. Pub. No. 2015/0296743 (“Pet treat dispensing container with cap fastener”). These documents are incorporated herein by reference to the extent not inconsistent herewith.

With respect to the numbered clauses and claims expressed below, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise. Also in the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### CLAUSES

1. (Independent) A handle assembly 300 or other leash configuration method (e.g. implemented in flow 600) using a heat press 218 having one or more heat press platens 219 with a (nominal) length 289 (“L”), the method comprising:

obtaining a plurality of straps including a first strap 141, 241, 741 and a second strap 142, 242, 842 at least one of which comprises a particular strap 141, 142, 241, 242, 741, 842, 843 with (at least) a first image 133, 433 affixed thereon via a heat press 218 with an entire length 132 thereof placed (nominally) along/adjacent a length 289 of (at least one of) the one or more heat press platens 219; and

constructing a first handle assembly 300 to include a first joint 174, 374 and a second joint 175, 375 and part of the first strap 141, 241, 741 forming a first handle 152, 352 extending between the first joint 174, 374 and the second joint 175, 375 and part of the second strap 142, 242, 842 forming a corresponding first handle support 162, 362 also extending between the first joint 174, 374 and the second joint 175, 375 so that a length 183, 383 of the first handle 152, 352 exceeds a length 384 of the first handle support 162, 362.

2. The method of any of the above CLAUSES wherein the constructing the first handle assembly 300 comprises:

causing a length 183, 383 of the first handle 152, 352 to exceeds a length 384 of the first handle support 162, 362 by roughly 2 centimeters (i.e. by more than 4 mm and by less than 10 centimeters).

3. The method of any of the above CLAUSES wherein the constructing the first handle assembly 300 comprises:

causing a length 183, 383 of the first handle 152, 352 to exceeds a length 384 of the first handle support 162, 362 by about 2 centimeters (i.e. by more than 1 centimeter and by less than 4 centimeters).

4. The method of any of the above CLAUSES comprising:

using the first handle assembly 300 as a central component of a one-off leash (e.g. as a completed leash configuration system 100, 700, 800 having a total length T>L) that is longer than the one or more heat press platens 219.

5. The method of any of the above CLAUSES comprising:

using the first handle assembly 300 as a central component of a small-run leash (i.e. in a manufacturing project in which fewer than 500 leashes with nominally identical labeling are made in a single batch).

6. The method of any of the above CLAUSES comprising:

using the first handle assembly 300 as a central component of a small-run leash (i.e. in a manufacturing project) in which fewer than 50 leashes with nominally identical labeling are made in a single batch.

7. The method of any of the above CLAUSES comprising:

configuring the first handle assembly 300 so that the length 183, 383 of the first handle 152, 352 exceeds the length 384 of the first handle support 162, 362 by more than 1.5 cm and less than 4 cm.

8. The method of any of the above CLAUSES comprising:

configuring the first handle assembly 300 so that the length 183, 383 of the first handle 152, 352 exceeds the length 384 of the first handle support 162, 362 by more than 1 cm and less than 5 cm.

9. The method of any of the above CLAUSES comprising:

making the particular strap 141, 142, 241, 242, 741, 842, 843 from a material that is primarily a synthetic resin (i.e. more than 50% by weight).

10. The method of any of the above CLAUSES comprising:

making the first strap 141, 241, 741 from a material that is primarily a synthetic resin (i.e. more than 50% by weight).

11. The method of any of the above CLAUSES comprising:

making the particular strap 141, 142, 241, 242, 741, 842, 843 from a material that is more than 60% polyester by weight.

12. The method of any of the above CLAUSES comprising:

making the first strap 141, 241, 741 from a material that is more than 60% polyester by weight.

13. The method of any of the above CLAUSES comprising:

making the particular strap 141, 142, 241, 242, 741, 842, 843 from a material that comprises more than 80% by weight of at least one of polyester or nylon.

14. The method of any of the above CLAUSES comprising:

making the first strap 141, 241, 741 from a material that comprises more than 80% by weight of at least one of polyester or nylon.

15. The method of any of the above CLAUSES comprising:

making the particular strap 141, 142, 241, 242, 741, 842, 843 from a material having a (nominal) thickness 303 of about 0.9 millimeters.

16. The method of any of the above CLAUSES comprising:

making the first strap 141, 241, 741 from a material having a (nominal) thickness 303 of about 0.9 millimeters.

17. The method of any of the above CLAUSES comprising:

making the particular strap 141, 142, 241, 242, 741, 842, 843 from a material that is (thin, narrow, or otherwise) weak enough as to be unsuitable for managing a big dog (i.e. more than 60 lbs.) without an augmented intermediate handle assembly 300 as described herein but in which a strength-indicative rating (e.g. “okay for dogs up to 70 lbs.”) of a leash that includes the augmented intermediate handle assembly 300 signals that some such dogs may nevertheless be managed.

18. The method of any of the above CLAUSES comprising:

making the first strap 141, 241, 741 from a material that is (thin, narrow, or otherwise) weak enough as to be unsuitable for managing a big dog (i.e. more than 60 lbs.) without an augmented intermediate handle assembly 300 as described herein but in which a strength-indicative rating (e.g. “okay for dogs up to 70 lbs.”) of a leash that includes the augmented intermediate handle assembly 300 signals that some such dogs may nevertheless be managed.

19. The method of any of the above CLAUSES comprising:
making the first strap 141, 241, 741 from a material that is (thin, narrow, or otherwise) weak enough as to be (nominally or effectively) unsuitable for managing a medium-size dog (i.e. more than 30 lbs.) without an augmented intermediate handle assembly 300 as described herein but in which a strength-indicative rating (e.g. “not for use with dogs more than 40 lbs.”) of a leash that includes the augmented intermediate handle assembly 300 signals that some such dogs may nevertheless be managed.

20. The method of any of the above CLAUSES comprising:

making the first strap 141, 241, 741 from a material that is (thin, narrow, or otherwise) weak enough as to be (nominally or effectively) unsuitable for managing a medium-size dog (i.e. more than 30 lbs.) without an augmented intermediate handle assembly 300 as described herein but in which a strength-indicative rating (e.g. “not for use with dogs more than 40 lbs.”) of a leash that includes the augmented intermediate handle assembly 300 signals that some such dogs may nevertheless be managed.

21. The method of any of the above CLAUSES comprising:

making the particular strap 141, 142, 241, 242, 741, 842, 843 from a material (nominally) at most 1.1 mm thick.

22. The method of any of the above CLAUSES comprising:

making the first strap 141, 241, 741 from a material (nominally) at most 1.1 mm thick.

23. The method of any of the above CLAUSES comprising:

making the particular strap 141, 142, 241, 242, 741, 842, 843 from a material (nominally) at most 1.0 mm thick.

24. The method of any of the above CLAUSES comprising:

making the first strap 141, 241, 741 from a material (nominally) at most 1.0 mm thick.

25. The method of any of the above CLAUSES comprising:

making the particular strap 141, 142, 241, 242, 741, 842, 843 from a material at least 0.6 mm thick.

26. The method of any of the above CLAUSES comprising:

making the first strap 141, 241, 741 from a material at least 0.6 mm thick.

27. The method of any of the above CLAUSES comprising:

making the particular strap 141, 142, 241, 242, 741, 842, 843 from a material at least 0.8 mm thick.

28. The method of any of the above CLAUSES comprising:

making the first strap 141, 241, 741 from a material at least 0.8 mm thick.

29. The method of any of the above CLAUSES comprising:

making the particular strap 141, 142, 241, 242, 741, 842, 843 wider than 1.3 cm.

30. The method of any of the above CLAUSES comprising:

making the first strap 141, 241, 741 wider than 1.3 cm.

31. The method of any of the above CLAUSES comprising:

making the particular strap 141, 142, 241, 242, 741, 842, 843 wider than 1.8 cm.

32. The method of any of the above CLAUSES comprising:

making the first strap 141, 241, 741 wider than 1.8 cm.

33. The method of any of the above CLAUSES comprising:

making the particular strap 141, 142, 241, 242, 741, 842, 843 from a material having a width 131 of about 2 cm.

34. The method of any of the above CLAUSES comprising:

making the first strap 141, 241, 741 from a material having a width 131 of about 2 cm.

35. The method of any of the above CLAUSES comprising:

making the particular strap 141, 142, 241, 242, 741, 842, 843 narrower than 2.6 cm.

36. The method of any of the above CLAUSES comprising:

making the first strap 141, 241, 741 narrower than 2.6 cm.

37. The method of any of the above CLAUSES comprising:

using the first handle assembly 300 as a central component (i.e. spanning a midsection) of a leash (e.g. as a completed leash configuration system 100, 700, 800 having a total length T>L) that is longer than the one or more heat press platens 219, comprising:
allowing a distal end portion 191 of the first strap 141, 241, 741 to (pass or otherwise) extend through a swivel snap jaw ring 787; and
coupling the swivel snap jaw ring 787 to the first strap 141, 241, 741 by forming a joint 774 across the distal end portion within 5 centimeters of the swivel snap jaw ring 787.

38. The method of any of the above CLAUSES comprising:

using the first handle assembly 300 as a central component of a leash (e.g. as a completed leash configuration system 100, 700, 800 having a total length T>L) that is longer than the one or more heat press platens 219, comprising:
allowing a distal end portion 191 of the first strap 141, 241, 741 to (pass or otherwise) extend through a swivel snap jaw ring 787; and
coupling the swivel snap jaw ring 787 to the first strap 141, 241, 741 by forming a joint 774 across the distal end portion within 5 centimeters of the swivel snap jaw ring 787.

39. The method of any of the above CLAUSES comprising:

using the first handle assembly 300 as a central component of a leash (e.g. as a completed leash configuration system 100, 700, 800 having a total length T>L) that is longer than the one or more heat press platens 219, comprising:
allowing a distal end portion 191 of the first strap 141, 241, 741 to (pass or otherwise) extend through a swivel snap jaw ring 787;
coupling the swivel snap jaw ring 787 to the first strap 141, 241, 741 by forming a joint 774 across the distal end portion within 5 centimeters of the swivel snap jaw ring 787; and
constructing a second handle assembly 300 to include a first joint 774 and a second joint 775 and part of the first strap 141, 241, 741 forming a second handle 752 and part of the first strap 141, 241, 741 forming a second handle support 762, wherein the second handle 752 and the second handle support 762 each extend between the first and second joints 774, 775 of the second handle assembly 300.

40. The method of any of the above CLAUSES comprising:

using the first handle assembly 300 as a central component of a leash (e.g. as a completed leash configuration system 100, 700, 800 having a total length T>L with no components 881, 882 disengaged) that is longer than the one or more heat press platens 219, comprising:
allowing a proximal end portion 892 of the second strap 842 to (pass through or otherwise) extend through a first snap clip component 881, 882; and
allowing a first end portion of a third strap 843 to (pass through or otherwise) extend through a second snap clip component (e.g. as shown or reversing the components 881-882 as shown) configured to click together with the first snap clip component 881, 882.

41. The method of any of the above CLAUSES comprising:

using the first handle assembly 300 as a central component of a leash that is longer than the one or more heat press platens 219, comprising:
allowing a proximal end portion 892 of the second strap 842 to (pass through or otherwise) extend through a first snap clip component 881, 882;
allowing a first end portion of a third strap 843 to (pass through or otherwise) extend through a second snap clip component (e.g. as shown or reversing the components 881-882 as shown) configured to click together with the first snap clip component 881, 882; and
forming a more-proximal additional handle by constructing a joint 876 that affixes a proximal portion 892 (e.g. as shown in FIG. 8) of the second strap with a second end portion of the third strap 843 that is opposite to the first end portion of the third strap 843.

42. (Independent) A handle assembly 300 or other leash configuration system 100, 700, 800 made using a heat press 218 having one or more heat press platens 219 with a (nominal) length 289, the system 100, 700, 800 comprising:

a plurality of straps including a first strap 141, 241, 741 and a second strap 142, 242, 842, at least one of which comprises a particular strap 141, 142, 241, 242, 741, 842, 843 with at least a first image 133, 433 affixed thereon via the heat press 218 with an entire length 132 thereof placed (nominally) along/adjacent a length 289 of (at least one of) the one or more heat press platens 219; and

a first handle assembly 300 configured to include a first joint 174, 374 and a second joint 175, 375 and part of the first strap 141, 241, 741 forming a first handle 152, 352 extending between the first joint 174, 374 and the second joint 175, 375 and part of the second strap 142, 242, 842 forming a corresponding first handle support 162, 362 also extending between the first joint 174, 374 and the second joint 175, 375 so that a length 183, 383 of the first handle 152, 352 exceeds a length 384 of the first handle support 162, 362 by roughly 2 centimeters (i.e. by more than 4 millimeters and less than 10 centimeters).

43. The system 100, 700, 800 of any of the above SYSTEM CLAUSES wherein the first and second joints 174, 175 of the first handle assembly 300 each comprise one or more adhesives 411.

44. The system 100, 700, 800 of any of the above SYSTEM CLAUSES wherein the first and second joints 374, 375 of the first handle assembly 300 each comprise one or more rows 412 of stitches.

45. The system 100, 700, 800 of any of the above SYSTEM CLAUSES wherein the first and second joints 174, 175, 374, 375 of the first handle assembly 300 each comprise one or more rivets 413.

46. The system 100, 700, 800 of any of the above SYSTEM CLAUSES wherein the first and second joints 174, 175, 374, 375 of the first handle assembly 300 each comprise one or more staples.

47. The system 100, 700, 800 of any of the above SYSTEM CLAUSES wherein the first and second joints 174, 175, 374, 375 of the first handle assembly 300 each comprise one or more clasps.

48. The system 100, 700, 800 of any of the above SYSTEM CLAUSES wherein the first image 133, 433 comprises a strength-indicative rating (e.g. marked with “up to 50 lb. dogs” or the like) pertaining to some or all of the leash configuration system.

49. The system 100, 700, 800 of any of the above SYSTEM CLAUSES wherein the first image 133, 433 comprises a source identifier (e.g. a trademark identifying a maker or distributor of the leash).

50. The system 100, 700, 800 of any of the above SYSTEM CLAUSES wherein the first image 133, 433 comprises a composition identifier (e.g. marked with “100% polyester” or the like) or other design specification pertaining to some or all of the leash configuration system.

51. The system 100, 700, 800 of any of the above SYSTEM CLAUSES wherein (at least part of) the first image 133, 433 and (at least part of) the second strap 142, 242, 842 are on opposite surfaces 301, 302 of the first strap 141, 241.

52. The system 100, 700, 800 of any of the above SYSTEM CLAUSES wherein the first (contiguous or other) image 133, 433 is longer than 10 cm along the particular strap 141, 142, 241, 242, 741, 842, 843.

53. The system 100, 700, 800 of any of the above SYSTEM CLAUSES whereby a more durable tethering (in terms of tension before failure) is maintained from a distal end portion 191 of the first strap 141, 241, 741 to the first handle 152, 352 than to the first handle support 162 by virtue of the first strap 141, 241, 741 extending all the way from the distal end portion 191 of the first strap 141, 241, 741 through the first handle 152, 352.

54. The system 100, 700, 800 of any of the above SYSTEM CLAUSES wherein many fibers 471 (i.e. dozens or more) of the first strap 141, 241, 741 each extend from a distal end portion 191 of the first strap 141, 241, 741 continuously through the first handle 152, 352.

55. The system 100, 700, 800 of any of the above SYSTEM CLAUSES wherein many fibers 471 of the first strap 141, 241, 741 each extend from a distal end portion 191 of the first strap 141, 241, 741 continuously through the first handle 152, 352 but in which no fiber extends from the distal end portion 191 of the first strap 141, 241, 741 continuously through (any part of) the first handle support 162, 362.

56. The system 100, 700, 800 of any of the above SYSTEM CLAUSES comprising:

a third strap 843 directly or otherwise coupled to the second strap 142, 742, 842; wherein a second image heat-pressed upon one of the straps comprises at least one of a strength-indicative rating or a source identifier.

57. The system 100, 700, 800 of any of the above SYSTEM CLAUSES comprising:

a third strap 843 directly or otherwise coupled to the second strap 142, 742, 842; wherein a second image heat-pressed upon one of the straps comprises a strength-indicative rating.

58. The system 100, 700, 800 of any of the above SYSTEM CLAUSES wherein another image heat-pressed upon one of the straps comprises a composition identifier (e.g. “100% polyester”).

59. The system 100, 700, 800 of any of the above SYSTEM CLAUSES wherein the first strap is more than 40% polyester by weight.

60. The system 100, 700, 800 of any of the above SYSTEM CLAUSES wherein the first strap is more than 80% polyester by weight.

61. The system 100, 700, 800 of any of the above SYSTEM CLAUSES wherein the system comprises a completed leash longer than 1.25 meters.

62. The system 100, 700, 800 of any of the above SYSTEM CLAUSES wherein the system includes a swivel snap hook 728 at a distal end thereof (i.e. farthest from a user of the system 100, 700, 800).

63. The system 100, 700, 800 of any of the above SYSTEM CLAUSES wherein the second strap 142, 242, 842, 842 directly engages a first snap-clip component 881, wherein a third strap 843 directly engages a second snap-clip component 882, and wherein the first snap-clip component 881 directly engages the second snap-clip component 882 (generally) at a proximal end of a leash comprising the system 100, 700, 800.

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

1. A leash configuration method using a heat press having one or more heat press platens with a length L, said method comprising:
obtaining a first strap and a second strap each about 1 meter long, said first strap having a first image longer than 10 centimeters affixed thereon via said heat press with an entire length of said first strap placed adjacent said one or more heat press platens;
constructing a D-shaped first handle assembly to include a first joint, a second joint, part of said first strap forming a first handle extending between said first and second joints, and part of said second strap forming a first handle support also extending between said first and second joints; wherein said first strap has a thickness of about 0.9 millimeters and a width of about 2 centimeters; wherein a length of said first handle exceeds a length of said first handle support by about 2 centimeters; and wherein said first image and said second strap are on opposite surfaces of said first strap; whereby a more durable tethering is maintained from a distal end portion of said first strap to said first handle than to said first handle support by virtue of said first strap extending continuously from said distal end portion of said first strap through said first handle; and
using said first handle assembly as a central component of a leash having a total length T>L, comprising:
allowing a distal end portion of said first strap to extend through a swivel snap jaw ring;
coupling said swivel snap jaw ring to said first strap by forming another joint across said first strap within 5 centimeters of said swivel snap jaw ring.

2. The leash configuration method of claim 1 wherein said using said first handle assembly as said central component of said leash comprises:
constructing a second handle assembly to include first and second joints, wherein part of said first strap forms a second handle and another part of said first strap forms a second handle support and wherein said second handle and said second handle support both extend between said first and second joints of said second handle assembly.

3. The leash configuration method of claim 1 wherein said using said first handle assembly as said central component of said leash comprises:
making said first strap from a material that is weak enough as to be unsuitable for managing a big dog without an augmented intermediate handle assembly but in which a strength-indicative rating of said leash signals that said big dog may nevertheless be managed safely using said first handle.

4. A leash configuration method using a heat press having one or more heat press platens, said method comprising:
obtaining a first strap and a second strap each about 1 meter long, said first strap having a first image longer than 10 centimeters affixed thereon via said heat press with an entire length of said first strap placed adjacent said one or more heat press platens; and
constructing a first handle assembly to include a first joint, a second joint, part of said first strap forming a first handle extending between said first and second joints, and part of said second strap forming a first handle support also extending between said first and second joints; wherein said first strap has a thickness of about 0.9 millimeters and a width of about 2 centimeters and wherein a length of said first handle exceeds a length of said first handle support by roughly 2 centimeters.

5. The leash configuration method of claim 4, wherein said first image and said second strap are on opposite surfaces of said first strap.

6. The leash configuration method of claim 4, wherein many fibers of said first strap each extend from a distal end portion of said first strap continuously through said first handle.

7. The leash configuration method of claim 4, comprising:
using said first handle assembly as a central component of a leash, comprising:
allowing a distal end portion of said first strap to extend through a swivel snap jaw ring; and
coupling said swivel snap jaw ring to said first strap by forming a joint across said first strap within 5 centimeters of said swivel snap jaw ring.

8. The leash configuration method of claim 4, comprising:
using said first handle assembly as a central component of a leash that is longer than said one or more heat press platens, comprising:
allowing a proximal end portion of said second strap to extend through a first snap clip component;
allowing a first end portion of a third strap to extend through a second snap clip component configured to click together with said first snap clip component; and
forming an additional handle by constructing a joint that affixes a proximal portion of said second strap with a second end portion of said third strap that is opposite to said first end portion of said third strap.

9. The leash configuration method of claim 4 wherein said first image comprises at least one of a composition identifier or a strength-indicative rating.

10. The leash configuration method of claim 4, comprising:
using said first handle assembly as a central component of a leash.

11. The leash configuration method of claim 4, wherein said obtaining said first strap and said second strap comprises:
configuring said first and second straps each to be about 0.6 millimeters thick and about 2 centimeters wide, wherein said first image comprises a strength-indicative rating.

12. The leash configuration method of claim 4, wherein said obtaining said first strap and said second strap comprises:
configuring said first and second straps each to be more than 0.5 millimeters and less than 1.1 millimeters thick.

13. The leash configuration method of claim 4, comprising:
using said first handle assembly as a component of a leash, comprising:
constructing a second handle assembly to include first and second joints, wherein part of said first strap forms a second handle and another part of said first strap forms a second handle support and wherein said second handle and said second handle support both extend between said first and second joints of said second handle assembly.

14. A leash configuration system made using a heat press having one or more heat press platens, said system comprising:
a first strap and a second strap each about 1 meter long, said first strap having a first image longer than 10 centimeters affixed thereon via said heat press with an entire length of said first strap placed adjacent said one or more heat press platens; and
a first handle assembly that includes a first joint, a second joint, part of said first strap forming a first handle extending between said first and second joints, and part of said second strap forming a first handle support also extending between said first and second joints;
wherein said first strap has a thickness of about 0.9 millimeters and a width of about 2 centimeters and wherein a length of said first handle exceeds a length of said first handle support by roughly 2 centimeters.

15. The leash configuration system of claim 14 wherein many fibers of said first strap each extend from a distal end portion of said first strap continuously through said first handle and wherein many fibers of said first strap each extend from a distal end portion of said first strap continuously through said first handle and wherein said first and second joints of said first handle assembly each comprise one or more stitches, adhesives, rivets, or staples.

16. The leash configuration system of claim 14 wherein a second image heat-pressed upon one of said straps comprises at least one of a strength-indicative rating or a source identifier and wherein said system comprises a completed leash longer than 1.25 meters.

17. The leash configuration system of claim 14 wherein many fibers of said first strap each extend from a distal end portion of said first strap continuously through said first handle and wherein said first image and said second strap are on opposite surfaces of said first strap.

18. The leash configuration system of claim 20 whereby a more durable tethering is maintained from a distal end portion of said first strap to said first handle than to said first handle support by virtue of said first strap extending continuously from said distal end portion of said first strap through said first handle.

19. The leash configuration system of claim 20 wherein said second strap directly engages a first snap-clip component, wherein a third strap directly engages a second snap-clip component, and wherein said first snap-clip component directly engages said second snap-clip component at a proximal end thereof.

20. A leash configuration system made by the method of claim 4.
